(19) United States
(12) Patent Application Publication
(10) Pub. No.: US 2012/0230269 A1
(43) Pub. Date: Sep. 13, 2012

(54) INTEGRATED ACCESS APPARATUS FOR ALL-IP CONVERGED NETWORK

(75) Inventors: Noik PARK, Daejeon-si (KR); Young Boo KIM, Gongju-si (KR); Soon Seok LEE, Daejeon-si (KR); Heuk PARK, Daejeon-si (KR); Jong Geun PARK, Daejeon-si (KR); Jongtae SONG, Daejeon-si (KR); Sunghyun YOON, Daejeon-si (KR); Eun Joo KIM, Seoul (KR); Kyung-Gyu CHUN, Daejeon-si (KR)

(73) Assignee: Electronics and Telecommunications Research Institute, Daejeon (KR)

(21) Appl. No.: 13/414,910

(22) Filed: Mar. 8, 2012

(30) Foreign Application Priority Data
Mar. 8, 2011 (KR) 10-2011-0020601
Mar. 7, 2012 (KR) 10-2012-0023468

(51) Int. Cl. H04W 28/02; H04W 72/04

(52) U.S. Cl. 370/329; 370/328

(57) ABSTRACT

An integrated access system for All-IP converged network is provided. According to an aspect, by integrating the common factors of existing complex wireless networks to load-reduce and simplify the wireless networks and convert them using Internet access technology to thereby simplify a network architecture, integratively operating radio accesses, ensuring end-to-end quality, and providing service adaptiveness, easiness in operation, CAPEX/OPEX, and excellent service adaptiveness can be achieved.

### CROSS-REFERENCE TO RELATED APPLICATION

This application claims the benefit under 35 U.S.C. §119(a) of Korean Patent Applications No. 10-2011-0020601, filed on Mar. 8, 2011, and No. 10-2012-0023468, filed on Mar. 7, 2012, the entire disclosures of which are incorporated herein by reference for all purposes.

### BACKGROUND

1. Field

The following description relates to an All-IP converged access system capable of establishing a variety of IP networks based on different standards using single IP technology, and a control method thereof.

2. Description of the Related Art

Mobile-WiMAX and Evolved Packet System (EPS) including 3^{rd} Generation Partnership Project (3GPP) Long Term Evolution (LTE) that is currently discussed as representative 4G technology are exposing limitation due to their problems as follows. The Mobile-WiMAX and EPS use individual independent traffic control methods (3GPP-GTP/WiMAX-GRE) for each standard in order to separate/manage and charge subscriber traffic, which causes control complexity and has been a roadblock to control unification with IP networks. The 3GPP is planning independent development of wired and wireless technologies through LTE and Evolved Packet Core (EPC) for network integration. However, since the EPC itself has been taking over the tunneling control structure of a General Packet Radio Service (GPRS) of 3G, the EPC could not solve the 3G's problems. Furthermore, since no architecture for providing mobility between heterogeneous networks (for example, between 3GPP and non-3GPP) has been yet decided, no solution for providing seamless IP mobility has been proposed although applications of MIP, PMIP, etc. are trying to provide mobility.

Meanwhile, the 3GPP/Mobile-WiMAX (WiBro) network uses a different resource control system from IP networks, which becomes a factor of increasing network overhead for broadcast/multicast. Also, the 3GPP continues to add nodes/functions, such as MBMS, BM-SC, etc., and the Mobile-WiMAX (WiBro) continues to add nodes/functions, such as MBS proxy, MCBCS, etc., resulting in a further increase of network complexity.

In view of QoS and service control, in the case of Mobile-WiMAX (WiBro), a policy distribution function for matching an IMS QoS system in order to accept the IMS architecture of 3GPP is defined and added as a separate node, which also leads to a continuous increase of network complexity.

### SUMMARY

The following description relates to a low-power, large-capacity integrated access system that can establish a variety of wireless subscriber networks based on different standards, such as a 3GPP Evolved Packet System (EPS), Wibro/Wibro Evolution, etc., using single IP technology, that can introduce a single IP-based control system that can be applied from a subscriber network to a backbone network to thereby optimize an IP network, and that can establish an access media independent packet-based network without having to use a multi-network architecture dependent on a mobile communication standard through termination of existing and future mobile communication specifications.

In one general aspect, there is provided an integrated access apparatus for All-IP converged network, comprising a flow-based LTE base station having a function of separating traffic for each subscriber/service in unit of an IP flow and managing/controlling the separated traffic, and a flow-based M-WiMAX base station having the function of separating traffic for each subscriber/service in unit of an IP flow and managing/controlling the separated traffic.

The integrated access apparatus further includes a Unified Control Entity (UCE) configured to generate a path request message for a terminal using a source IP address of the terminal, and to provide IP packet header information (5-tuple) to the base station, wherein the IP packet header information is used for routing of the terminal and included in a response message to the path request message.

The integrated access apparatus further includes a packet border gateway (PBGW) configured to receive a path request message from the mobility management entity, to acquire IP packet header information (5-tuple) for routing of the terminal based on a source IP address of the terminal, and to provide the IP packet header information (5-tuple) to the mobility management entity.

Therefore, by integrating the common factors of existing complex wireless networks to load-reduce and simplify the wireless networks and convert them using Internet access technology to thereby simplify a network architecture, integratively operating radio accesses, ensuring end-to-end quality, and providing service adaptiveness, easiness in operation, CAPEX/OPEX, and excellent service adaptiveness can be achieved.

Also, by improving the functions of network equipment to optimize the network equipment without having to change the functions of terminals, it is possible to significantly improve a network architecture while providing an All-IP converged service.

Other features and aspects will be apparent from the following detailed description, the drawings, and the claims.

### BRIEF DESCRIPTION OF THE DRAWINGS

FIG. 1 is a conceptual view illustrating a 3GPP Evolved Packet System (EPS) network and a M-WiMAX network.

FIG. 2 is a conceptual view illustrating an example of a network.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

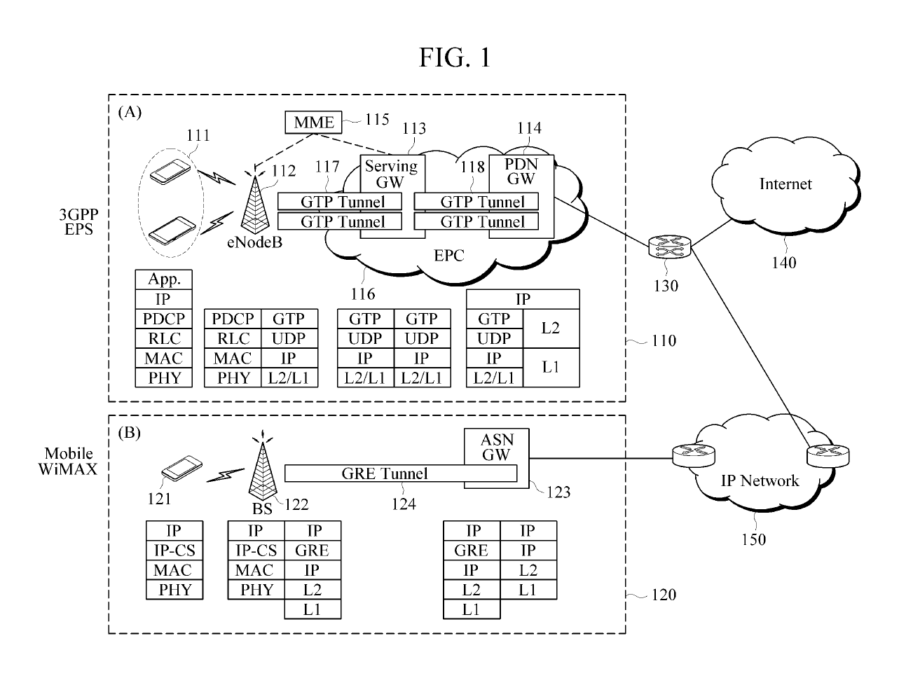

FIG. 1 is a conceptual view illustrating a 3GPP Evolved Packet System (EPS) network 110 and a M-WiMAX network 120.

The EPS network 110 may be defined by Long Term Evolution (LTE) and an Evolved Packet Core (EPC), wherein the LTE defines a radio interface between terminals 11 and a base station (eNodeB) 112 and the EPC is defined by a Mobility Management Entity (MME) 115, a Serving Gateway (SGW) 113, and a PDN Gateway (PGW) 114 (3GPP TS36.300).

The M-WiMAX network 120 is composed of a terminal 121, a Base Station (BS) 122, and an Access Service Network Gateway (ASN-GW) 123 (WiMAX Forum Network Architecture, Stage2).

The EPS network 110 interworks with a general Internet 140 through an Internet Exchange Point (IX) 130, and the M-WiMAX 120 interworks with the general Internet 140, the EPS network 110, etc. through the IX 130 via an IP network 150.

The EPS network 110 uses GPRS Tunneling Protocol (GTP) tunnels 117 and 118 for traffic separation for each subscriber/service, etc., and the W-WiMAX network 120 also uses a Generic Routing Encapsulation (GRE) tunnel 124 for the similar purpose, which increases the complexity of traffic control and has been a roadblock to the evolution into an All-IP converged network.

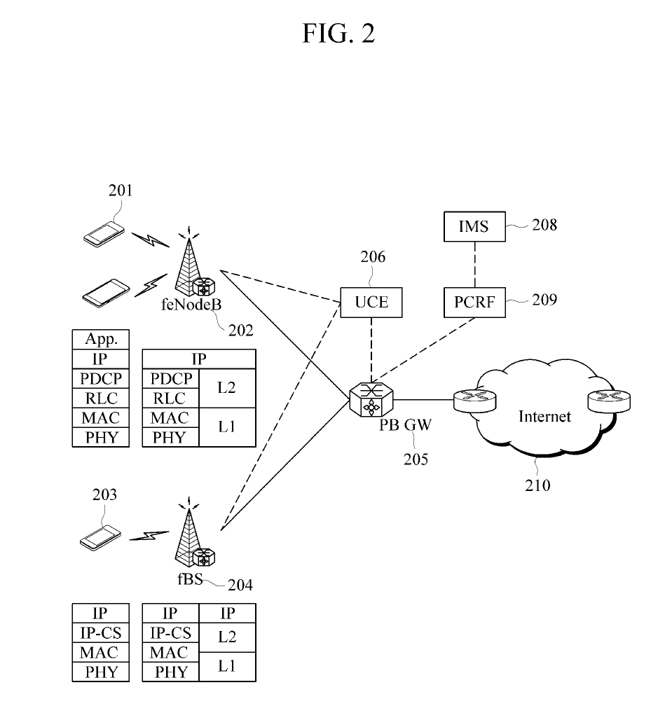

FIG. 2 shows examples of a converged network and an integrated access apparatus for the converged network.

Referring to FIG. 2, the integrated access apparatus includes a first base station 202, a second base station 204, a United Control Entity (UCE) 206, and a packet border gateway (PBGW) 205.

In FIG. 2, the first and second base stations 202 and 204 may communicate with a LTE terminal 201 and a M-WiMAX terminal 203, respectively. At this time, it is assumed that the LTE and M-WiMAX terminals 201 and 203 are not changed.

Also, the first and second base stations 202 and 204 may additionally have a function of managing/controlling traffic for each subscriber/service in unit of IP flow. For example, the first base station 202 may be a LTE base station having a function of managing/controlling traffic for each subscriber/service in unit of IP flow. In this specification, the LTE base station 202 may be simply referred to as a flow based eNodeB (feNB). As another example, the second base station 204 may be a M-WiMAX base station having a function of managing/controlling traffic for each subscriber/service in unit of IP flow, and in this specification, the M-WiMAX base station 204 may be simply referred to as a flow based BS (fBS).

The UCE 206 may generate a path request message for a terminal using the source IP address of the terminal, and provide IP packet header information (5-tuple) to the first and second base stations 202 and 204, wherein the IP packet header information (5-tuple) is used for routing of the terminal and will be included in a response message to the path request message. For example, the UCE 206 may set or manage at least one of a data path, integrated mobility, and radio resources between heterogeneous subscriber networks, based on the IP packet header information (5-tuple). In other words, the UCE 206 may be in charge of data routing of the M-WiMAX ASN GW, integrated mobility management between heterogeneous accesses, and integrated radio resource management for LTE/M-WiMAX, as well as the functions of Mobility Management Entity (MME) defined in 3GPP TS36.300.

If the UCE 206 transfers the IP packet header information to the first and second base stations 202 and 204, the first and second base stations 202 and 204 may secure a data path based on the IP packet header information. For example, the first base station 202 maps a Radio Bearer ID (RBID) to tuple information of an IP packet, based on the IP packet header information (5-tuple), to thereby secure a data path. As another example, the second base station 204 maps a Connection ID (CID) to tuple information of an IP packet, based on the IP packet header information (5-tuple), to thereby secure a data path.

The PBGW 205 accepts both the first and second base stations 202 and 205, and controls data traffic between the PBGW 205 and the first base station 202 or the second base station 204 based on the IP packet (flow), not based on GTP or GRE. Also, the data traffic that is controlled based on the IP packet (flow) is transferred to the Internet 210 via the PBGW 205.

Also, the PBGW 205 interworks with an IP Multimedia Subsystem (IMS) 208 and a Policy and Charging Rule Function (PCRF) 209 for service call control, service QoS control, etc.

Hereinafter, in the case where the first base station 202 is feNodeB and the second base station 204 is fBS, data layers, signal layers, integrated resource management, IP mobility control, service recognition automatic handover, etc., which are newly defined, will be described.

<Data Layers>

In traffic control between the PBGW 205 and the feNodeB 202 or fBS 204, for IP packet-based control, not for GTP- or GRE-based control, the feNodeB 202, fBS 204, and PBGW 205 have a Micro-Flow traffic control function of managing/controlling traffic for each subscriber/service. The Micro-Flow traffic control function can separate/manage traffic for each subscriber/service with respect to signals (data) received through the Packet Data Convergence Protocol (PDCP) of the feNodeB 202 and the Convergence Sublayer (CS) of the fBS 204.

Thereby, a method of mapping a RBID of an existing eNodeB to a GTP Tunnel Endpoint ID (TEID) between the eNodeB and a SGW to secure a data path is changed to a method of mapping the RBID to 5-tuple information of an IP packet to secure a data path, and also a method of mapping a CID of a CS layer in an existing BS to a GRE key value between the BS and ASNGW to secure a data path is changed to a method of mapping the CID to 5-tuple information of an IP packet to secure a data path. An IP flow recognized by the feNodeB 202 and fBS 204 is transferred to the PBGW 205 through a layer-2 transmission function such as the Ethernet, and the PBGW 205 performs an IP transfer function, such as QoS application, routing, etc., of the IP flow. Also, the PBGW 205 performs an additional function of providing a security tunnel and IP mobility. Meanwhile, the feNodeB 202 and fBS 204 process charging information, measurement information, etc. of user traffic, based on micro-flow.

<Signal Layers>

In the EPC signal layer, there are signal schemes between a terminal and an eNB, between a MME and a terminal, between a MME and an eNB, and between a MME and a SGW (3GPP TS24.301, TS39.413, TS29.272, TS23.401). Also, In the M-WiMAX signal layer, there are direct signal schemes between a terminal and a BS and between a BS and an ASNGW. Since the current example considers no case where radio periods and terminals are changed, the signal schemes between the terminal and eNB and between the BS and terminal accept existing signal schemes as they are, and signals between the MME and terminal are based on the signal scheme between the UCE and terminal. The other signal schemes are unified to the signal schemes between the UCE and PBGW and between the UCE and base station (feNB or fBS).

<Integrated Resource Management>

Heterogeneous radio resources of LTE and M-WiMAX networks are integratively managed in order to maximize the use efficiency of radio resources. That is, the used bandwidth for each cell, the number of used radio channels for each cell, the number of subscribers for each cell, the number of subscriber traffic sessions for each cell, etc. are collected from the LTE and M-WiMAX networks, and then the collected information is integratively managed. The integrated management of radio resources is aimed at automatically handing over subscribers to a cell (a homogeneous or heterogeneous cell) having many available radio resources according to the use rate of radio resources for each cell, and this function will be described later.

<IP Mobility Control>

For IP mobility control, an IP address system in which an ID for identifying a terminal is separated from a locator for data transmission is introduced. The terminal ID is used to identify and authenticate a subscriber terminal, and the locator is used to register/manage the location information of the subscriber terminal and transmit subscriber traffic. The address of the PBGW 205 is generally used as the locator, and in a special case where high security is required, a specific ID may be separately allocated to the terminal.

In the case where the address of the PBGW 205 is used as the locator, a basic IP-in-IP type of security tunnel is established between PBGWs, and in the case of a service where high security is required, an IP-in-IP type of security tunnel is established between terminals based on locators allocated to the terminals. If a locator is changed due to a terminal accessing a network or connecting to another PBGW, etc., a data path is established and thereafter the PBGW registers the location information of the terminal in the UCE 206 based on the locator.

When a certain terminal requests another terminal to send a call such as data transmission, the PBGW 205 recognizes the location of the other terminal by inquiring the UCE 206 about the locator of the other terminal and receiving a response from the UCE 206, and then establishes a data path (a security tunnel). This operation allows direct communication between terminals for a non-IMS service. If an IP address is changed upon movement of a terminal, the UCE 206 detects the movement of a L2 layer and requests a target PBGW to establish a data path. After the target PBGW establishes a data path, the target PBGW registers the location information of the moved terminal in the UCE 206, and then the data path of the source PBGW is released. For this function, the PBGW 205 may have a function of registering the location information of a terminal in the UCE 206 or inquiring the UCE 206 about the location information of a terminal, and a function of mapping a terminal ID to routing/switching information about downward traffic to the terminal and managing the mapped information. In addition, the PBGW 205 may have an IP-in-IP En-capsulation/De-capsulation function for data transmission.

<Service Recognition Automatic Hand-Over>

When heterogeneous cells geomatically overlap each other, when a cell which a subscriber currently accesses has too many users, or when resources for receiving a service requested by a user are insufficient, the QoS of the corresponding user service may be influenced. In this case, if a heterogeneous cell adjacent (geographically overlapping with) to the corresponding cell has idle resources, the user terminal is connected to the adjacent cell, thereby providing a high quality service. For this operation, the UCE 206 and/or PBGW 205 recognizes the service characteristics for user traffic and determines the states of available resources through an integrated resource management function to thereby reconnect the terminal to the heterogeneous cell.

The present invention can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An integrated access apparatus for All-IP converged network, comprising a base station having a function of separating traffic for each subscriber/service in unit of an IP flow and managing/controlling the separated traffic.

2. The integrated access apparatus of claim 1, wherein the base station includes a first base station and a second base station which is a different kind of base station from the first base station.

3. The integrated access apparatus of claim 2, wherein the first base station is a flow-based Long Term Evolution (LTE) base station having the function of separating traffic for each subscriber/service in unit of an IP flow and managing/controlling the separated traffic.

4. The integrated access apparatus of claim 2, wherein the second base station is a flow-based M-WiMAX base station having the function of separating traffic for each subscriber/service in unit of an IP flow and managing/controlling the separated traffic.

5. The integrated access apparatus of claim 1, further comprising a Unified Control Entity (UCE) configured to generate a path request message for a terminal using a source IP address of the terminal, and to provide IP packet header information (5-tuple) to the base station, wherein the IP packet header information is used for routing of the terminal and included in a response message to the path request message.

6. The integrated access apparatus of claim 5, wherein the UCE sets and manages at least one of a data path between heterogeneous subscriber networks, integrated mobility, and radio resources.

7. The integrated access apparatus of claim 5, wherein the UCE is in charge of routing of M-WiMAX ASN GW, integrated mobility management between heterogeneous radio accesses, and integrated radio resource management for LTE/M-WiMAX, as well as Mobility Management Entity (MME) defined in 3GPP TS36.300.

8. The integrated access apparatus of claim 5, wherein the base station secures a data path by mapping a Radio Bearer ID (RBID) to tuple information of an IP packet, based on the IP packet header information (5-tuple).

9. The integrated access apparatus of claim 5, wherein the base station secures a data path by mapping a Connection ID (CID) to tuple information of an IP packet, based on the IP packet header information (5-tuple).

10. The integrated access apparatus of claim 5, further comprising a packet border gateway (PBGW) configured to receive a path request message from the mobility management entity, to acquire IP packet header information (5-tuple) for routing of the terminal based on a source IP address of the terminal, and to provide the IP packet header information (5-tuple) to the mobility management entity.

11. The integrated access apparatus of claim 10, wherein the packet border gateway controls and manages data traffic from the base station, based on an IP packet, not based on a GPRS tunneling protocol (GTP) or Generic Routing Encapsulation (GRE).

12. The integrated access apparatus of claim 10, wherein the packet border gateway sets, if receiving a request for a predetermined service from the terminal, Quality of Service (QoS) for the requested service, and transmits the response message to the terminal.
